(19) United States
(12) Patent Application Publication
(10) Pub. No.: US 2018/0064093 A1
(43) Pub. Date: Mar. 8, 2018

(54) Animal Bite Deterrent Device

(71) Applicant: Alan Spence, Lexington, TX (US)

(72) Inventor: Alan Spence, Lexington, TX (US)

(21) Appl. No.: 15/794,239

(22) Filed: Oct. 26, 2017

Related U.S. Application Data
(63) Continuation-in-part of application No. 14/606,141, filed on Jan. 27, 2015.
(60) Provisional application No. 61/935,979, filed on Feb. 5, 2014.

(51) Int. Cl. A01M 29/18; F21V 33/00; A01M 29/10

(52) U.S. Cl. CPC A01M 29/18; F41H 13/0081; A01M 29/10; F21V 33/0076

(57) ABSTRACT

Disclosed are hand-held devices containing a combination of an ultra-bright LED light component and, an additional component selected from one or more of the following: an electronic-shock device, video camera and/or an ultrasound generating component powered by a battery, together with means to activate each. The device(s) may be configured to allow activation of one or all of the lights, an electronic-shock device, and ultrasound components disposed in a suitable housing. The device(s) may have a structural design similar to a hand gun but optionally colored in such a way as to not be confused with a real firearm.

### CROSS REFERENCE TO RELATED APPLICATIONS

This application is a continuation-in-part of U.S. Ser. No. 14/606,141 which claims benefit of Provisional Application Ser. No. 61/935,979 filed Feb. 5, 2014. The contents and disclosures of the application are incorporated herein by reference in its entirety for all purposes.

### BACKGROUND

### Field of Invention

The invention relates to deterrent of animal attacks, specifically to hand-held devices for deterring animals from attacking and biting humans.

### Background

According to the American Humane Association, an estimated 4.7 million dog bites occur in the U.S. each year, 800,000 dog bites require medical care, approximately two-thirds of bites occurred on or near the victim's property, and most victims knew the dog. The insurance industry pays more than $1 billion in dog-bite claims each year. The U.S. Postal Service reported that 5,879 postal workers were victims of dog bites in the fiscal year 2012. Dog bites to postal employees peaked during the mid-1980s when more than 7,000 letter carriers were attacked annually.

While this is a recognized problem, many animal control officers' (ACO) departments will not allow their officers to carry an ASP (Bite Stick) or O.C. Spray, as an animal bite deterrent device for whatever reason. This leaves the ACO totally vulnerable to an attack by an aggressive dog or other animals, unless they have something like a Catch/Control pole with them.

There are a number of animal deterrent devices available such as the Dog Dazer II Dog Deterrent and OnGuard™ devices that emit a high frequency sound audible to dogs but not to humans. DE 33161196, published Nov. 8, 1984 to Gerber, described a device utilizing electronic frequencies in the ultrasonic range above 20000 Hz that are inaudible to humans. See also U.S. Pat. No. 6,250,255, published Jun. 26, 2001, describing pulsating or vibrating ultrasound for deterring animals.

All of these devices, however, are somewhat limited in effectiveness. The present invention overcomes many of those limitations and is designed specifically to be directly marketed to the vast animal care and control field, as well as postal and utility workers.

### SUMMARY

This invention is hand-held devices containing a combination of an ultra-bright LED light component and, an additional component selected from one or more of the following: an electronic-shock device, video camera and/or an ultrasound generating component powered by a battery, together with means to activate each. The device(s) may be configured to allow activation of one or all of the lights, an electronic-shock device, and ultrasound components disposed in a suitable housing. The device(s) may have a structural design similar to a hand gun but optionally colored in such a way as to not be confused with a real firearm.

The invention is also a method of use of the described device and a kit of component

### DESCRIPTION OF FIGURES

A more complete understanding of the method and apparatus of the present invention may be had by reference to the following detailed description when taken in conjunction with the accompanying drawings, wherein:

FIG. 1 is perspective view of the exterior of an embodiment of the invention and some of the components.

FIG. 2 is a sectional view of an embodiment of the invention showing the arrangement of components.

FIG. 3 is an end view of the embodiment of FIGS. 1 and 2.

FIG. 4 is perspective view of the exterior of another embodiment of the invention and some of the components.

FIG. 4A is an end view of the device shown in FIG. 4

FIG. 5 is a sectional view of the embodiment shown in FIG. 4 showing the arrangement of components.

FIG. 6 is a schematic of the electrical system of an embodiment of the invention.

FIG. 7 is a side view of another embodiment of the invention showing the arrangement of components.

FIG. 8 is perspective view of the exterior of the embodiment of the invention shown in FIG. 7.

FIG. 8 is an end view of the device shown in FIG. 7.

FIG. 9 is a side view of the embodiment shown in FIG. 7.

FIG. 10 is an end view of the device shown in FIG. 7.

FIG. 11 is another end view of the device shown in FIG. 7.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION

In the following detailed description, reference is made to the accompanying drawings that form a part hereof, and in which is shown by way of illustration specific implementations (embodiments) which may be practiced. These implementations are described in sufficient detail to enable those skilled in the art to practice the implementations, and it is to be understood that other implementations may be utilized. Further, logical, mechanical, and other changes may be made without departing from the scope of the implementations. The following detailed description is, therefore, not to be taken in a limiting sense.

In broad scope the device(s) of this invention in their embodiments are hand-held devices containing a combination of an ultra-bright LED light and, optionally an ultrasound generating component device, an electronic shock device, and a video camera, together with means to activate each. The device(s) may be configured to allow activation of one or any combination of components disposed in a suitable housing.

The device(s), in some embodiments, has a structural design similar to a “Taser™” or “hand gun” but preferably colored in such a way as to not be confused with a real firearm. Holsters currently being manufactured may be used to carry/secure the device, or a special holster configured to fit the devices(s) may be provided. The device will be activated very much like a Taser, except that there are no removable parts, and it costs nothing to use. Upon deployment, (activating the trigger/switch component) a pulsating (or strobing) ultra-bright LED light (located in the forward end-muzzle of the device is activated. In addition, an ultrasonic “whistle” (preferably three frequency), which only the dog can hear may be activated. In some embodiments, the device will also contain a video camera and an electronic shock unit (stun gun).

Not all dogs respond to single frequency, so three cycling frequencies are more effective. The frequency that dogs hear is between of 40 Hz to 60,000 Hz, whereas humans can only hear sounds approximately within the frequencies of 20 Hz and 20,000 Hz. An available ultrasonic whistle starts at the low range and stops at the peak Hz. The generator cycles through the three frequencies.

Electronic shock unit, Taser™, gun, and electronic stun gun as the terms are used herein are defined as in the web site www.quora.com/Whats-the-difference-between-a-stun-gun-and-a-taser-gun. “TASER is a brand name, and an acronym. The letters stand for Thomas A. Swift's Electric Rifle (Tom Swift is the central character in an old series of young adult novels). The TASER is different from most other stun guns in that it can shoot a pair of electrode darts about 20 feet to embed in the skin of the target. The darts are connected to the TASER body by wires, and the current is conducted along those wires. A TASER can also be used in a ‘drive stun’ mode, where the electrodes are pressed against the target's body while still attached to the TASER unit. This is how most other stun guns work. The user presses the electrodes against the target's body, and presses a button to deliver the current. All these devices deliver a very high voltage at a relatively low amperage. The effect is to momentarily paralyze the muscles and immobilize the target.” The taser or stun gun used in the device of this invention is as described as a “drive stun” as it does not have projectable electrodes and therefore does not require a gas cylinder or other means to project the electrodes. When activated, the static electricity discharges across the fixed electrodes to make a loud “pop” sound and a flash of light. If placed in contact with an animal or human and activated, it acts in the same manner as a stun gun of drive stun.

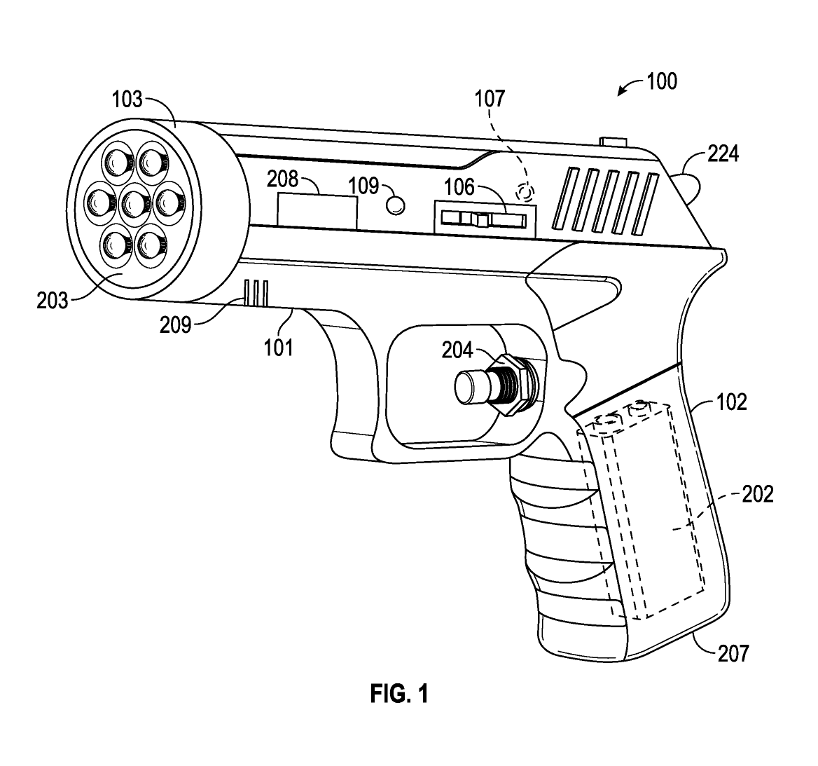

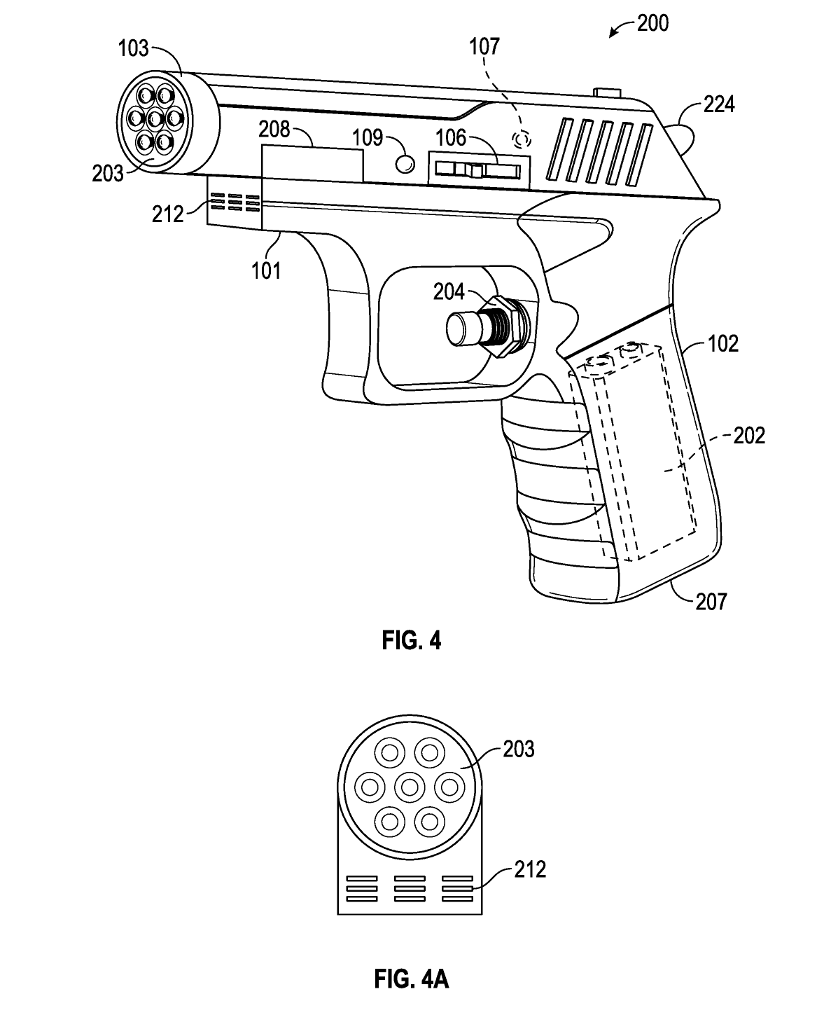

Referring to FIG. 1, there is illustrated an embodiment, 100, of the device(s) configured in the shape of a handgun. FIG. 4 is another embodiment. The body consists of the elongated barrel 101 and handle 102 that houses the device components and, in these embodiments, consists of four extruded (molded shell) plastic parts. A handgun-shaped housing or body is a very practical and convenient. Such shape can, for example, be carried in a pistol holster or in any other manner that pistols would be carried. The handgun shape is configured with a horizontal barrel (101) of a length (front to rear) at least 80% of a length measured from the topside of the barrel to the bottom of the handle (102). The handle extends downward from the barrel at an angle of about 90° to 140° measured from the bottom of the barrel at the trigger location. In a prototype, the barrel is about 7-inches in length, and the length of the handle, measured from bottom to top of the barrel is about 6 inches. The handle extends from the barrel at an angle of about 110°.

The housing 101 may otherwise be of any suitable and convenient shape such as an elongated cylinder (flashlight casing). It may be housed in a walking cane head, “billy club” and any other housing that will be apparent to those skilled in the art, but the handgun shape is preferred. The body (housing), 101/102, may be constructed of any suitable material—polymer materials are preferred. It will conveniently be constructed of molded interlocking pieces or sections so that it can be dissembled for repair or replacement of internal components. A preferred device is designed to carry like the way a “Taser′” would be. It is recommended to be carried on the left side (cross draw), as to not encumber the access to the user's “Bite Stick” or two-way radio. It is preferred that it may be colored brightly for safety as not to be confused with an actual firearm. Bright blues, yellows, greens, reds, blacks, and different colors on the barrel and handle are suitable. This will allow the devices to be easily distinguishable from a handgun or other device. For example, in the illustrated pistol-shaped body, the barrel may be black and the handle a bright green, yellow, red, and the like. The distal end on the barrel may also be of a different color.

The bulb end of a LED light array, 103, is disposed at the distal end of the barrel. The LED light, 203, is an ultra-bright LED light array such as found in ultra-bright flashlights. A super bright LED light with a flashing strobe (preferred) will temporarily blinds and confuses the dog and helps stop the approach of unwanted dogs up to approximately 40 feet. A training setting has also been included. An especially suitable LED light array is an array known as Advanced Focus System™.

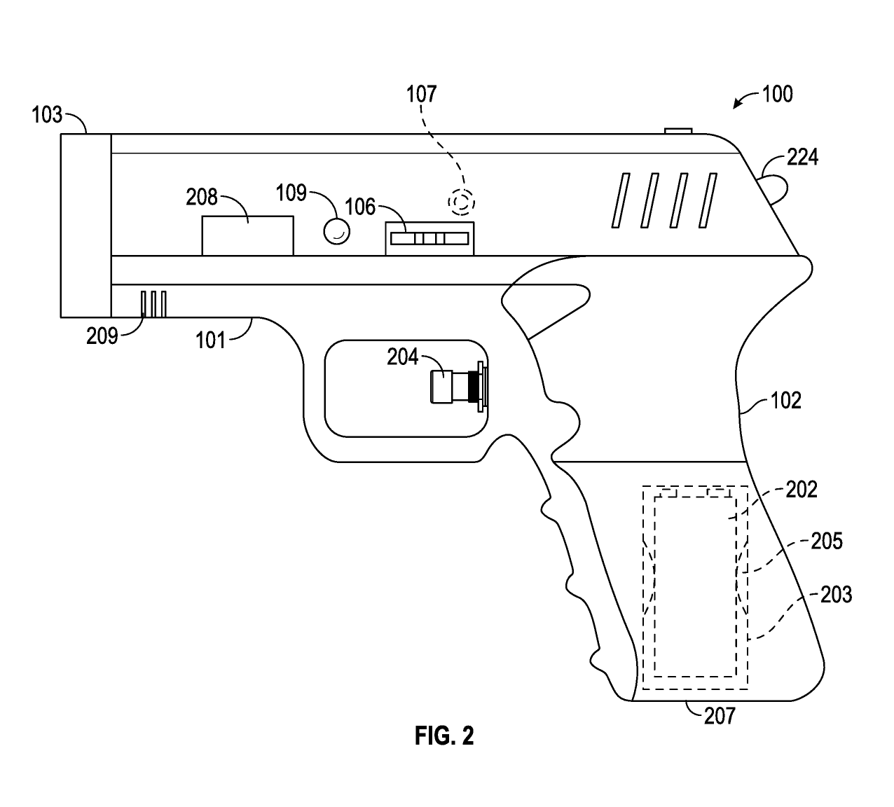

A battery 202 is fitted into a holding structure, 203 (in FIG. 2) in the handle of the pistol 102. An optional LED light to signal the battery status is shown as 109. In most applications, a 3.5-9-volt battery is sufficient. If an electronic shock unit is included, a rechargeable 3.54-volt lithium ion battery is best for the power supply, and it is recommended to be replaced as needed (approximately every 3-4 years).

In some embodiments, there is also disposed in the housing, an ultrasound generator, 208, (preferably a pulsating three frequency ultrasonic “whistle”), which only the dog can hear. “Ultrasound is an oscillating sound pressure wave with a frequency greater than the upper limit of the human hearing range. Ultrasound is thus not separated from ‘normal’ (audible) sound based on differences in physical properties, only the fact that humans cannot hear it. Although this limit varies from person to person, it is approximately 20 kilohertz (20,000 hertz) in healthy, young adults. Ultrasound devices operate with frequencies from 20 kHz up to several gigahertz.” See information: en.wikipedia.org/wiki/Ultrasound. There are slots 209 through which the sound is emitted. Item 224 is a switch that makes electrical connection between the components and battery so that they can be activated by the trigger switch, 204 adds an authentic appearance and is useful for steadying the device.

A three-way switch, 106, controls some functions of the device. The center position of the switch allows both the LED light and Ultrasound generator (or other components such as a electronic shock unit or camera) to operate simultaneously when the activation button is depressed, allowing power from the battery to activate the LED (pulsating) light assembly and the ultrasonic “whistle” simultaneously. In the far-left position, only the LED light is activated so it will act as a flashlight. In the far-right position, the device is totally deactivated. The trigger is a push button switch 204.

There may also be included a low-level LED light or a piezoelectric buzzer (107) to indicate when the ultrasound component is operating. There may also be an indicator for low battery.

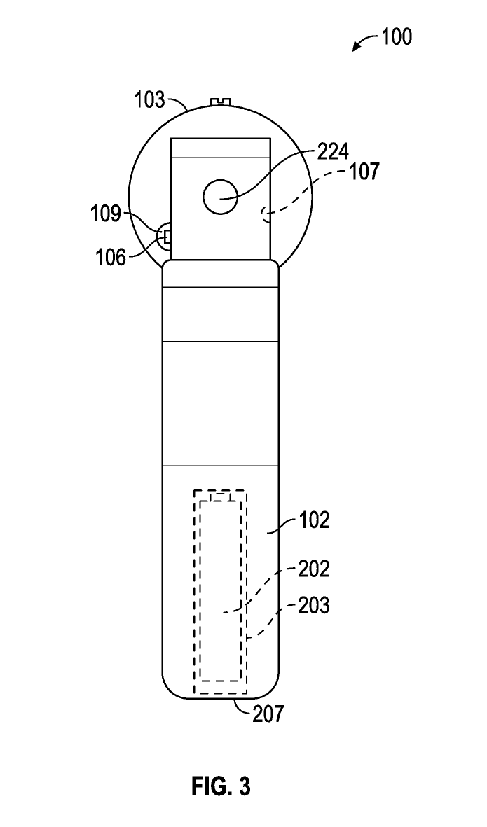

FIG. 2 is a sectional view of an embodiment of the invention showing the arrangement of the components. The device 100 is shaped like a handgun, but other shapes are within the scope of the invention. There is a container, 203, in the base of the device for the battery 202. A strip spring 205 holds the battery in place. There is also a handle butt cover, 207, to cover the bottom of the handle that may be attached in any convenient way, such as a sliding arrangement. The activation switch (trigger) is shown as item 204. An ultrasound generator 208 is disposed to focus sound out the bottom of the front (distal) end of the pistol. A LED light array 103 is positioned to be screwed into a receptacle in the front of the barrel. Both the LED light array and activation switch 204 may be configured to screw into a separate (e. g. metal or polymer square or rectangular pieces with female screw threads) component that will fit into recesses in the molded body to allow them to remain stable when the sections of the body are dissembled. An electronic board with the needed components can be disposed in an upright section of the barrel section of the device. FIG. 3 is an end view of the device of FIGS. 1-2.

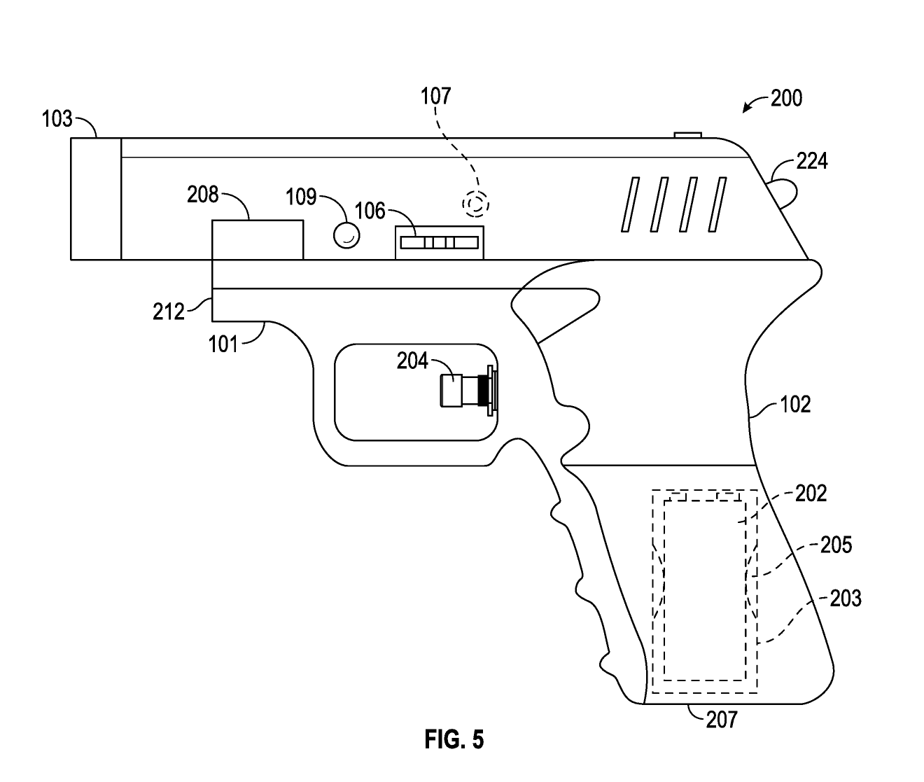

FIGS. 4, 4A, and 5 represent other embodiments of the device illustrated by FIGS. 1-3 with a different arrangement for the barrel end. It is much like the device of FIGS. 1-3 except that the slots 212 for emitting sound are located at the end of the barrel support.

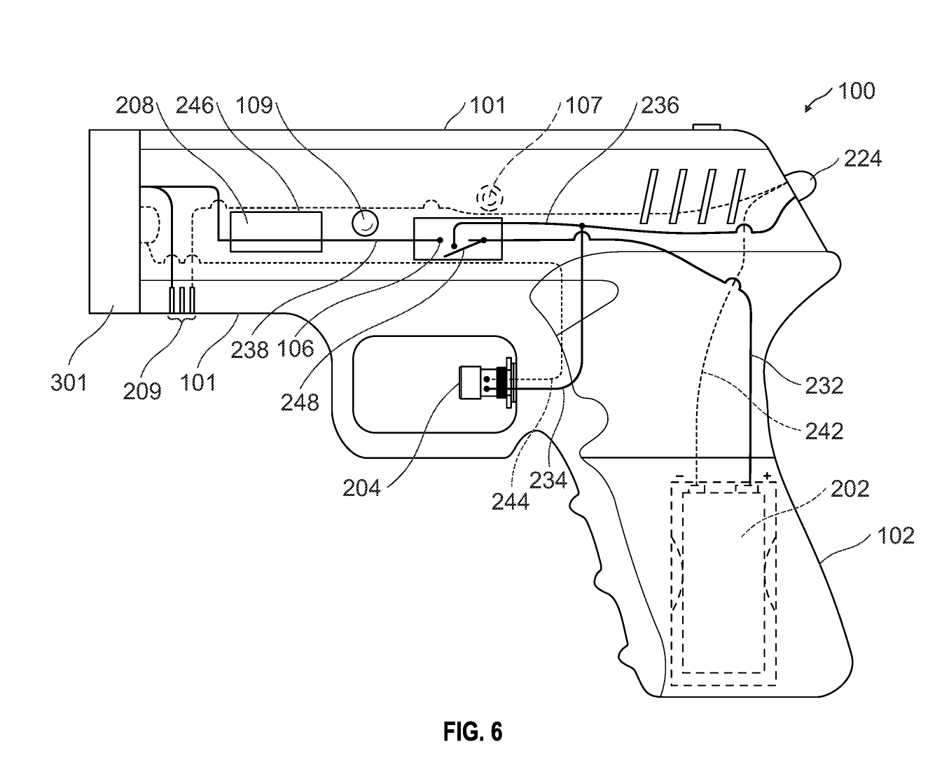

FIG. 6 demonstrates electrical connections for the embodiments illustrated in FIGS. 1-5 showing how the components may be electrically connected. The lines indicate how the battery, switches. LED light, and ultrasonic generator are connected in this embodiment. Switch 248 controls the electrical components connection to the battery. For example, the LED light may be intermediate or constant. Lines 232, 234, 236, 238, 242, 244, and 246 and are connections between the switch 224, trigger switch 204 and power supply battery 202. The heavy solid lines are the positive connections and the dotted lined the negative.

A prototype device as illustrated in the FIGS. 1-6 was constructed with the following specified components:
4 extruded (molded shell) plastic parts,
1 LED light assembly,
2 LED micro indicator lights,
2 micro switches,
1 momentary N/O switch (trigger),
1 ultrasonic device,
1 integrated circuit board (optional depending on LED array configuration),
1 3.5-9-volt battery (power supply).

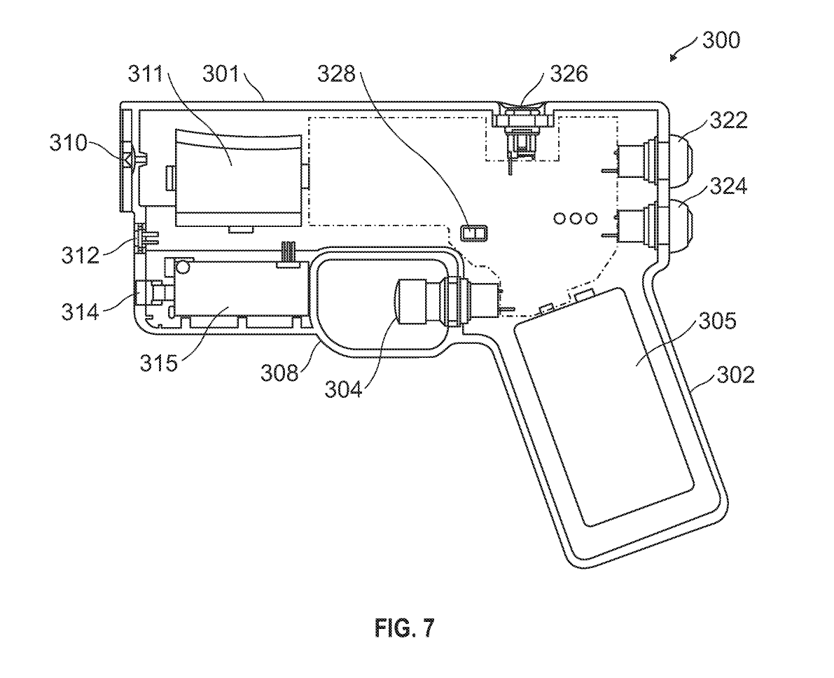

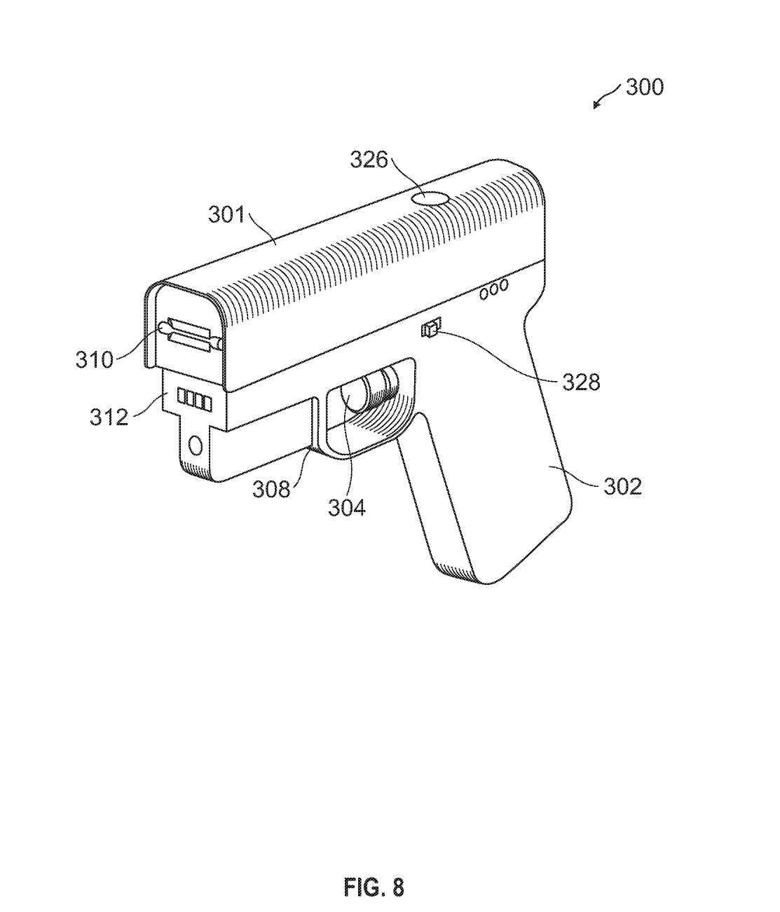

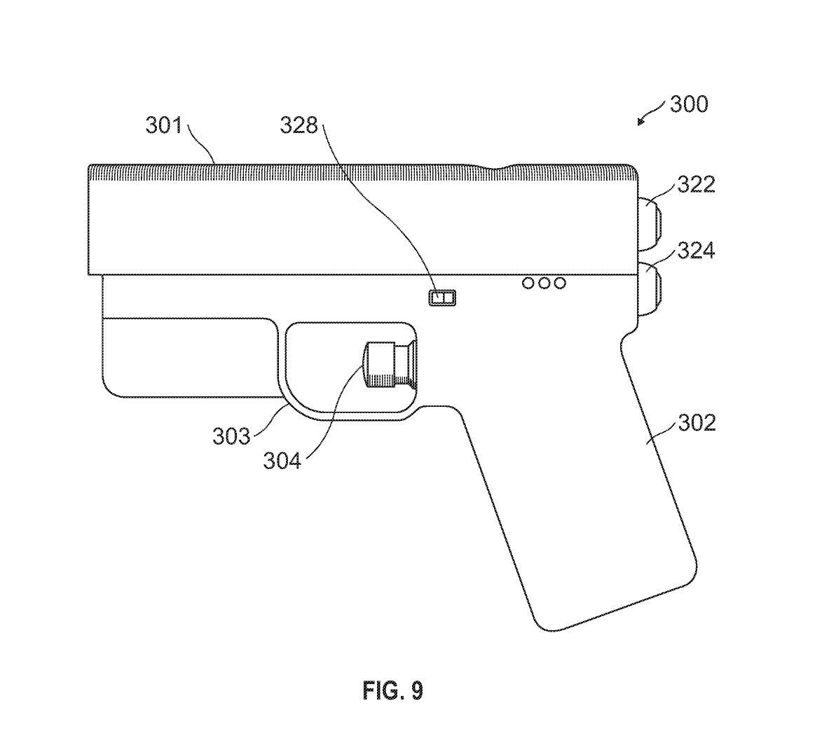

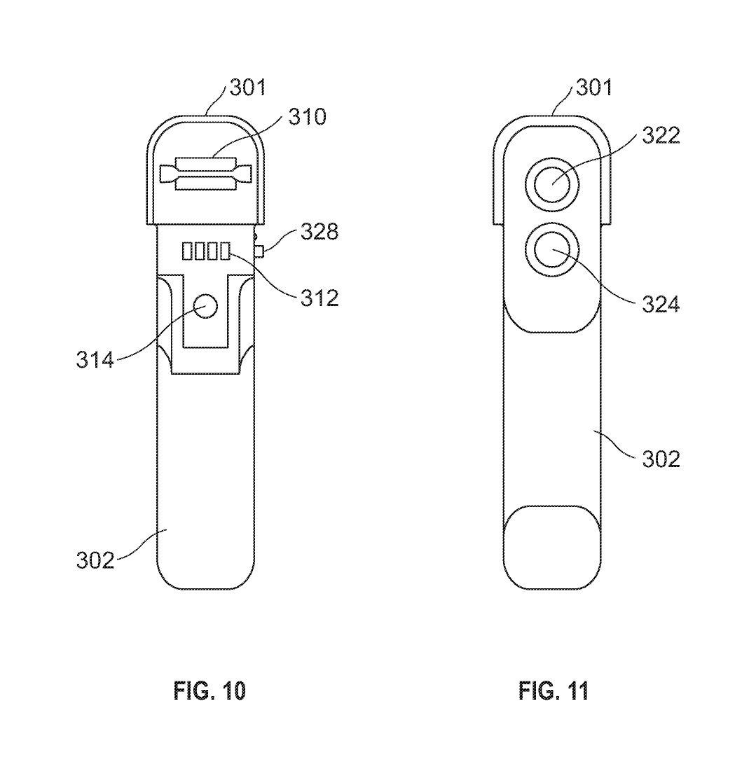

FIGS. 7-11 illustrate another, preferred, set of embodiments. In these embodiments, there is disposed in the housing body, 301/302 a battery compartment 305 in the handle 302, an LED light, 312, as described for the other embodiments above, an ultrasonic sound unit, 310, an electronic shock unit, 311/312, and a video camera, 314. The body housing is, like the other embodiments shaped like a handgun having a barrel, 301 and handle 302, in which the barrel is at least 80% the length (front to rear) as the length from the top of the barrel 301 to the bottom of the handle 302. Item 308 is a trigger switch guard. As with the other embodiments, the handle extends from the barrel at an angle of about 90° to 140° measured from the bottom of the barrel at the trigger location to the center of the handle. In a prototype, the barrel is about 7 inches in length, and the length of the handle, measured from bottom to top of the barrel is about 6 inches. The handle extends from the barrel at an angle of about 110°. As explained above, the electronic shock component will not be of the kind the shoots projectile electrodes (such as a Taser™), but only a spark that makes a loud pop and flash of light and which when in contact with an animal or human will act in same manner a stun gun or “drive stun” discharging high voltage energy to incapacitate the animal or human. When the electrical circuitry is connected (switch 322) the stun gun unit is activated by pressing the trigger switch. The video camera a is activated by switch 304 and does not need to the further activated by trigger switch 304.

In the FIGS. 7-11, there is a plug 326 to recharge the rechargeable battery that is housed in the battery compartment 305, and a switch 328 that controls the components as described in the other embodiments of FIGS. 1-6.

The device system may also comprise a fitted holster designed to be added to the officer's duty belt. The device and holster preferably weighs less than 18 ounces. Thus, the system may be sold as a kit comprised of the device with any combination of components as described above, a battery, and a holster. The kit may also, if desired, include operating instructions.

The device as illustrated may be worn as a part of their (an officers) everyday duty equipment, such as a “Bite Stick” or O.C. Spray, similar to the way a peace officer would carry a handgun or Taser™. It is recommended that the device be carried in a holster for security, but ready for immediate deployment.

In operation, the device may be also used as a distraction for a vicious animal if the light and sound prove ineffective. If the animal (dog) attack is not deterred by the activation of device, the ACO could actually “FEED” the device to the animal in order to proceed with deploying his/her bite stick.

Although the invention hereof has been described by way of specific embodiments, it will be evident that other adaptations and modifications can be employed without departing from the spirit and scope thereof. The terms and expressions employed herein have been used as terms of description and not of limitation; and thus, there is no intent of excluding equivalents, but on the contrary, it is intended to cover any and all equivalents that may be employed without departing from the spirit and scope of the invention.

1. An animal deterrent device comprising:
a housing for components formed into a handgun shape, having a barrel component with a front, rear. and top side, and a handle component the housing configured so that the barrel component is of a length measured front to rear of at least 80% of a length measured from the topside of the barrel to the bottom of the handle, and wherein the handle extends downward from the barrel at an angle of about 90 to 140° measured from the bottom of the barrel;
an ultra-bright LED light array disposed in the housing;
a battery disposed in the housing; and
an additional component(s) enclosed in the housing selected from the group consisting of ultra-sound generator, an ultrasound generator, an electronic stun gun component and a video camera.

2. The device of claim 1 wherein the housing is constructed of interlocking molded polymer sections.

3. The device of claim 1 wherein the ultra-bright LED light is strobing light.

4. The device of claim 1 wherein the ultrasound generator is capable of producing pulsing ultrasound waves of above about 20 kHz.

5. The device of claim 13 wherein the handgun shaped animal deterrent device has a container to house a battery disposed in the handgrip component.

6. The device of claim 13 wherein the handgun-shaped animal deterrent device has an activation device comprising a push button or trigger disposed in an angle between the barrel component and handgrip component.

7. The device of claim 1 wherein the additional components are an electronic stun gun component and a video camera.

8. The device of claim 1 wherein the housing is colored in bright colors.

9. The device of claim 1 comprising:
a single activation switch for each of the LED light and additional components or separate activation switches; and
a rechargeable battery for providing electrical current to the components.

10. The device of claim 9 comprising indicator lights or sounds that indicate when the ultrasound generator is operating and when the battery is low.

11. A method of deterring a threating animal or human comprising:
a) pointing a deterrent device at a threating animal or human, the device comprising:
a housing for components formed into a handgun shape having a barrel component with a front, rear, and top side, and a handle component the housing configured so that the barrel component is of a length measured front to rear of at least 80% of a length measured from the topside of the barrel to the bottom of the handle, and wherein the handle extends downward from the barrel at an angle of about 90 to 140° measured from the bottom of the barrel;
an ultra-bright LED light array disposed in the housing;
a battery disposed in the housing; and
an additional component housed in the housing selected from the group consisting of ultra-sound generator, an ultrasound generator, an electronic stun gun component and a video camera; and
b) activating ultra-bright LED light and the one or more of the additional components.

12. The device of claim 11 wherein the additional components are an electronic stun gun component and a video camera.

13. A kit comprising:
a device comprising a housing for components shaped into a handgun shape having a barrel component with a front, rear, and top side and a handle component the housing configured so that the barrel component is of a length measured front to rear of at least 80% of a length measured from the topside of the barrel to the bottom of the handle, and wherein the handle extends downward from the barrel at an angle of about 90 to 140° measured from the bottom of the barrel;
an ultra-bright LED light array disposed in the housing;
a battery disposed in the housing; and one or more additional component(s) enclosed in the housing selected from the group consisting of ultra-sound generator, an ultrasound generator, an electronic stun gun component and a video camera.

14. The kit of claim 13 comprising a holster configured to contain the device.
